(19) United States
(12) Patent Application Publication
(10) Pub. No.: US 2008/0297981 A1
(43) Pub. Date: Dec. 4, 2008

(54) Capacitor

(75) Inventors: Koji Endo, Hirakata City (JP); Yasuo Nakahara, Sumoto City (JP); Hiroshi Nonoue, Hirakata City (JP)

Correspondence Address: MASUVALLEY & PARTNERS, 8765 AERO DRIVE, SUITE 312, SAN DIEGO, CA, 92123, US

(73) Assignee: Sanyo Electric Co., Ltd., Moriguchi City (JP)

(21) Appl. No.: 12/150,157

(22) Filed: Apr. 25, 2008

(30) Foreign Application Priority Data
May 28, 2007 (JP) 2007-139887

(51) Int. Cl. H01G 9/032

(52) U.S. Cl. 361/502; 29/25.03

(57) ABSTRACT

The present invention is characterized by obtaining a high charge/discharge capacity upon high rate charging/discharging in a hybrid capacitor having characteristics of both an electric double layer capacitor and a lithium-ion secondary battery. Specifically, the present invention is a capacitor comprising: a positive electrode 1 composed of a polarizable electrode containing activated carbon; a negative electrode 2 containing as an anode active material a carbon material capable of inserting/extracting lithium ion; and a nonaqueous electrolyte containing lithium ion, wherein a charge cutoff potential for the negative electrode 2 is within the range of 0.15 to 0.25 V (vs. Li/Li⁺).

### TECHNICAL FIELD

The present invention relates to a hybrid capacitor having characteristics of both an electric double layer capacitor and a lithium-ion secondary battery.

### BACKGROUND OF THE INVENTION

In recent years, a hybrid capacitor comprising a positive electrode composed of a polarizable electrode using activated carbon, a negative electrode using a material in which a carbon material capable of inserting or extracting lithium ion is made to insert lithium ion as an anode active material and an organic electrolyte using a lithium salt as a solute has attracted attention. This is described in, for example, Unexamined Japanese Patent Application Publications No. H08-107048, H11-54383, or 2005-101409.

The hybrid capacitor is characterized by having performance combining characteristics of both a lithium-ion secondary battery and an electric double layer capacitor, and a higher energy density as compared with that of the electric double layer capacitor while having a high power density and good life-time characteristic similarly to the electric double layer capacitor.

The hybrid capacitor is appropriate for high power uses that are inappropriate for the lithium-ion secondary battery, and expected to be used for a power supply for a hybrid vehicle, or the like.

Unexamined Japanese Patent Application Publication No. H11-54383 proposes to set a ratio of a positive electrode capacity to a negative electrode capacity to 0.001 to 0.9. Also, Unexamined Japanese Patent Application Publication No. 2005-101409 proposes to adjust positive and negative electrode capacities such that a positive electrode potential is equal to or less than 4.2 V when a negative electrode potential reaches 0.005 V (vs. Li/Li⁺) by charging.

Further, Unexamined Japanese Patent Application Publication No. H11-54383 describes a carbon material such as natural graphite, artificial graphite, non-graphitizable carbon, graphitizable carbon, or low temperature baked carbon as a material for the negative electrode.

However, there exists a problem that if charging/discharging is performed at a high rate with the carbon material being used as the negative electrode material, a high charge/discharge capacity cannot be obtained.

### SUMMARY OF THE INVENTION

An object of the present invention is to provide a capacitor capable of obtaining the high charge/discharge capacity upon the high rate charging/discharging.

The present invention is a capacitor including a positive electrode composed of a polarizable electrode containing activated carbon, a negative electrode containing as an anode active material, a carbon material capable of inserting or extracting lithium ion, and a nonaqueous electrolyte containing lithium ion, and characterized in that a charge cutoff potential for said negative electrode is within a range of approximately 0.15 to 0.25 V (vs. Li/Li⁺).

By setting the charge cutoff potential for the negative electrode within the range of approximately 0.15 to 0.25 V (vs. Li/Li⁺) according to the present invention, the high discharge capacity can be obtained upon the high rate charging/discharging.

For a graphite-based carbon material such as natural graphite or artificial graphite among carbon materials, if lithium is inserted due to charging, a potential is rapidly decreased to exhibit a potential value equal to or less than approximately 0.2 V in a most range of a charge capacity.

FIG. 3 is a diagram illustrating an example of potential behavior of the negative electrode when lithium is inserted by such graphite-based carbon material. As illustrated in FIG. 3, the capacity is rapidly decreased at the potential of approximately 0.2 V or below if the high rate charging is provided to increase a charging current.

For graphitizable carbon obtained at a burning temperature of approximately 1000 to 1500° C. among non-graphite-based carbon materials, a capacity density region where the potential exhibits little change, as appeared in the graphite-based carbon material, is not present, and the potential is gradually decreased as lithium is inserted.

FIG. 4 is a diagram illustrating an example of potential behavior of the negative electrode when lithium is inserted by the graphitizable carbon. As illustrated in FIG. 4, as lithium is inserted, the negative electrode potential is gradually decreased. This tendency is the same as for the high rate charging such as with 5C. However, it turns out that in case when a large charging current is applied due to the high rate charging, the capacity is rapidly decreased at approximately 0.2 V or below.

As described above, if the carbon material is used, the charging current has a considerable effect at the negative electrode potential of approximately 0.2 V or below, and the capacity is rapidly decreased as the charging current is increased due to the high rate charging.

In the present invention, the charge cutoff potential for the negative electrode is set within the range of approximately 0.15 to 0.25 V (vs. Li/Li⁺), so that charging is provided without the use of the charging region as described above where the high rate charging has a considerable effect. For this reason, according to the present invention, the high charge/discharge capacity can be obtained even upon the high rate charging/discharging.

Accordingly, the present invention can achieve both a high energy density and a high power density, and also have excellent cycle performance upon the high rate charging/discharging.

For the carbon material used as the anode active material in the present invention, the above-described carbon materials can be used, which includes graphitizable carbon, non-graphitizable carbon, natural graphite, artificial graphite and low temperature baked carbon. From the perspective of increasing the energy density and charge/discharge capacity, the graphitizable carbon is particularly preferably used. The graphitizable carbon refers to carbon characterized by being gradually graphitized in case when a baking temperature exceeds approximately 1000° C., and being brought close to graphite in terms of an interlayer distance and a true specific gravity if the baking temperature exceeds approximately 2500° C. Among various types of graphitizable carbon, low crystalline graphitizable carbon is particularly preferable. The low crystalline graphitizable carbon is a carbon material baked at approximately 1000 to 2000° C., of which an interlayer distance is approximately 3.40 Å or more, and a true specific gravity is approximately 1.7 to 2.1 g/cm³. The graphitizable carbon includes coke or the like having been baked at the temperature range of approximately 1000 to 1500° C.

In the present invention, a ratio A/Q of a positive electrode capacity A to a negative electrode capacity Q upon discharging of a potential of the negative electrode from the charge cutoff potential to approximately 1.5 V (vs. Li/Li⁺) is preferably within the range of approximately 0.1 to 0.5. By setting the capacity ratio A/Q within such a range, a good cycle characteristic can be obtained with the charge/discharge capacity being high. In case when the capacity ratio A/Q is approximately 0.1 or less, the charge/discharge capacity may be decreased. On the other hand, in case when the capacity ratio A/Q exceeds approximately 0.5, a change in negative electrode potential becomes relatively large, so that the charge/discharge capacity may be decreased, and the cycle characteristic may be deteriorated.

In the present invention, the charge cutoff potential for the negative electrode is controlled within the range of approximately 0.15 to 0.25 (vs. Li/Li⁺). In the present invention, since the charge cutoff potential for the negative electrode is controlled within such a range, the carbon material, which is the anode active material, is preferably doped with lithium in advance before assembly of the capacitor. By doping lithium into the carbon material in advance, the negative electrode potential used for the charging/discharging can be set within the range as described above.

A method for doping lithium into the carbon material in advance includes a chemical or electrochemical method.

As the chemical method, the negative electrode and a required amount of lithium metal are immersed in an electrolyte with being brought into contact with each other, and then applied with heat to be thereby able to make the anode material insert lithium ion. As the electrochemical method, the negative electrode and lithium metal are made to face to each other via a separator, and then a constant current charge is performed between the negative electrode and the lithium metal in an electrolyte to insert lithium ion into the anode material.

The capacitor of the present invention can obtain the high charge capacity upon the high rate charging/discharging. Accordingly, it can be used as a capacitor charged/discharged with, for example, approximately 10C or higher. “Approximately 10C” refers to a charging/discharging current based on a current (1C) capable of discharging a cell capacity for approximately 1 hour.

The negative electrode in the present invention can be manufactured in a conventionally, commonly known manner. The negative electrode can be formed, for example, in such a way that the carbon material as the anode active material, a binder, and an electrically conductive agent (as needed) are mixed, which is then added with a solvent to form a slurry, and the slurry is coated on metal foil such as copper foil and then dried. Alternatively, the negative electrode may be fabricated by means of molding such as press molding.

The positive electrode in the present invention is structured by the polarizable electrode containing activated carbon. As the polarizable electrode containing activated carbon, any material can be used without particular limitation in case when the material can be used as a polarizable electrode for the electric double layer capacitor, hybrid capacitor, or the like. The positive electrode can be fabricated, for example, in such a way that the activated carbon, a binder, and carbon black (as needed) are mixed, which is then added into a solvent to form a slurry, and the slurry is coated on a current collector formed by metal foil such as aluminum foil, and then dried. Alternatively, it may be molded by press molding or the like. As the activated carbon, coconut husks, phenol resin, petroleum coke or the like activated by steam or KOH can be used. Alternatively, a mixture of them may be used as the activated carbon.

The nonaqueous electrolyte in the present invention is not particularly limited in case when it can be used for the electric double layer capacitor or hybrid capacitor, and the lithium salt as a solute includes, for example, LiPF₆, LiBF₄, LiClO₄, LiN(CF₃SO₂)₂, CF₃SO₃Li, LiC(SO₂CF₃)₃, LiAsF₆, LiSbF₆ or the like. Alternatively, any two or more of them may be used as the solute. Also, a solvent includes any one or more selected from a group consisting of ethylene carbonate, propylene carbonate, butylene carbonate, dimethyl carbonate, ethyl methyl carbonate, diethyl carbonate, sulfolane and dimethoxyethane.

A concentration of the lithium salt as the solute is not particularly limited, but typically, for example, approximately 0.1 to 2.5 mol/liter. According to the present invention, the high discharge capacity can be obtained upon the high rate charging/discharging.

### BRIEF DESCRIPTION OF THE DRAWINGS

FIG. 1 is a schematic cross-sectional view illustrating a capacitor according to one embodiment of the present invention.

FIG. 2 is a diagram for illustrating potential behavior of a negative electrode upon charging/discharging of the capacitor of the present invention.

FIG. 3 is a diagram illustrating an example of potential behavior of the negative electrode when lithium is inserted by a graphite-based carbon material.

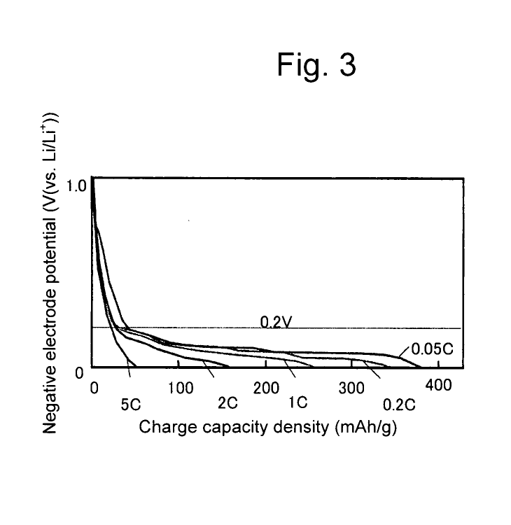

FIG. 4 is a diagram illustrating an example of potential behavior of the negative electrode when lithium is inserted by graphitizable carbon.

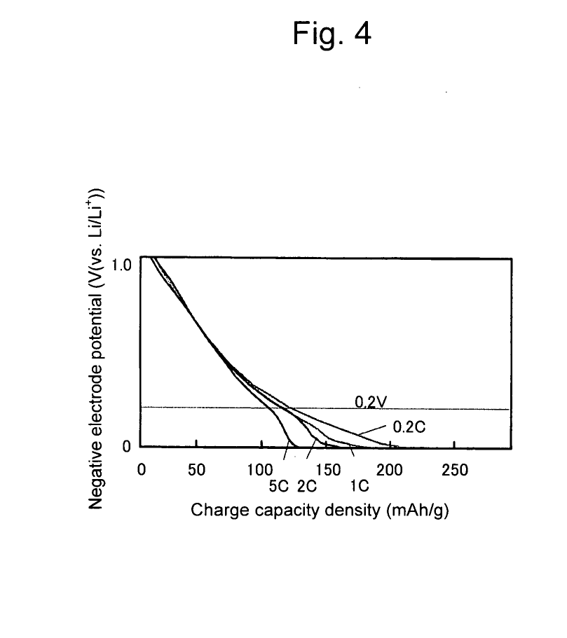

### DETAILED DESCRIPTION OF THE INVENTION

The present invention will hereinafter be described by a specific embodiment and example. However, it is not limited to the embodiment or example below, but may be embodied by appropriately modifying it without departing from the scope thereof.

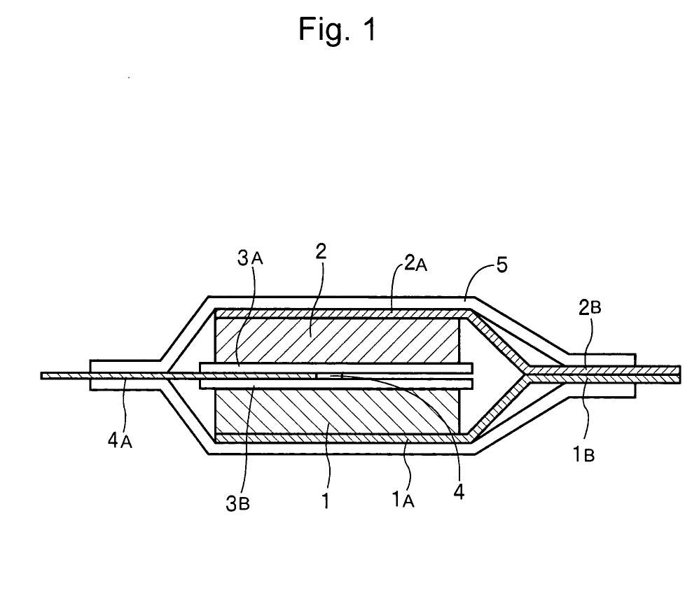

FIG. 1 is a schematic cross-sectional view illustrating a capacitor according to one embodiment of the present invention. In the capacitor illustrated in FIG. 1, a positive electrode 1 and a negative electrode 2 are provided so as to face to each other via separators 3A and 3B. The positive electrode 1 is composed of a polarizable electrode containing activated carbon. The negative electrode 2 is an electrode containing as an anode active material a carbon material capable of inserting or extracting lithium ion. The positive electrode 1 is provided with a positive electrode current collector 1A, which is attached with a positive electrode tab 1B, and the positive electrode tab 1B is drawn outside from an outer package 5.

The negative electrode 2 is also provided with a negative electrode current collector 2A, similarly to the positive electrode 1, and the negative electrode current collector 2A is attached with a negative electrode tab 2B, which is drawn outside from the outer package 5. The positive electrode current collector 1A is formed of, for example, aluminum, aluminum alloy, or the like. The negative electrode current collector 2A is formed of, for example, copper, nickel, alloy containing any of them, or the like.

In this embodiment, a reference electrode 4 made of metallic lithium is provided between the separators 3A and 3B. The reference electrode 4 is attached with an electrode tab 4A, which is drawn outside the outer package 5.

The separators 3A and 3B may be formed from a polyolefin-based separator or the like. Also, the outer package 5 may be formed from a laminate film, metal case, resin case, ceramic case or the like.

The capacitor in this embodiment is provided with the reference electrode 4, so that the reference electrode 4 can be used to measure a potential of the negative electrode 2.

However, the capacitor of the present invention does not have to be provided with the reference electrode as described above, and the number of separators between the positive and negative electrodes 1 and 2 may be one.

In case when the capacitor is not provided with the reference electrode as described above, a relationship between a potential of each of the positive and negative electrodes to be used and a cell voltage is to be obtained in advance. Thereby the potential of the negative electrode can be obtained from the cell voltage.

In the present invention, a charge cutoff potential for the negative electrode is set to approximately 0.15 to 0.25 V (vs. Li/Li⁺). Such negative electrode potential is a potential of the negative electrode under the condition of a rated cell voltage. Accordingly, it is only necessary to set the potential of the negative electrode under the rated cell voltage condition within the range of approximately 0.15 to 0.25 V (vs. Li/Li⁺).

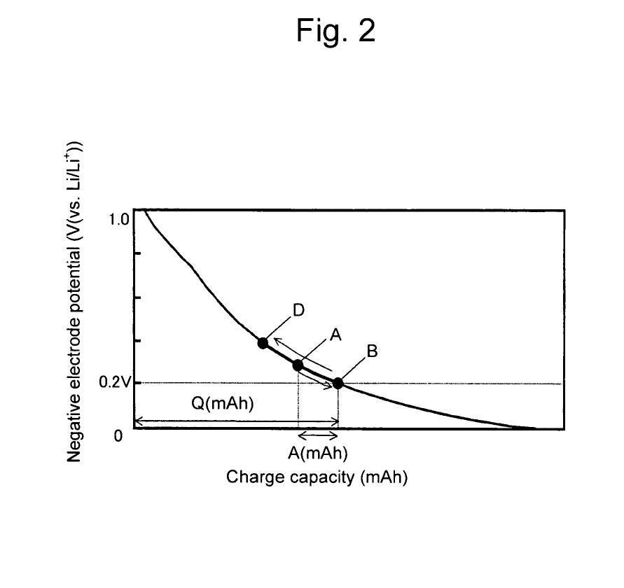

Potential behavior of the negative electrode upon charging/discharging of the capacitor of the present invention is described with reference to FIG. 2. FIG. 2 illustrates the potential behavior of the negative electrode for the case where lithium is firstly inserted in a test cell using lithium metal as a counter electrode. In the diagram, the negative electrode potential upon assembly is defined as the point A on the assumption that a material for the negative electrode preliminarily inserts lithium. By charging the test cell, the negative electrode potential moves toward the point B. When the test cell is charged to the rated cell voltage, the negative electrode potential reaches the point B. Then, by switching to discharging, the negative electrode potential passes through the point A to move to the point D. At the point D, the cell voltage is minimized. Subsequently, by repeating the charging and discharging, the negative electrode potential reciprocates between the points D and B. In the present invention, the negative electrode at the point B is set to approximately 0.15 to 0.25 V (vs. Li/Li⁺), and in this embodiment, it is set to approximately 0.2 V (vs. Li/Li⁺).

In order to adjust the negative electrode potential upon charging to the rated cell voltage, i.e., the charge cutoff potential for the negative electrode, to be equal to approximately 0.2 V (vs. Li/Li⁺), the anode material is made to preliminarily insert lithium as described below.

First, the potential behavior of the negative electrode is measured with sufficiently small current in the test cell using lithium metal as a counter electrode, as illustrated in FIG. 2. Based on a result of the measurement, an electric capacity Q (mAh) required for the negative electrode potential to be made equal to 0.2 V (vs. Li/Li⁺) is obtained.

Then, a capacity A (mAh) required for the positive electrode potential to change from a potential at the time when the positive electrode is immersed in an electrolyte, i.e., the positive electrode potential upon assembly of the capacitor, to a charge cutoff potential for the positive electrode is obtained. The capacity A is defined as a positive electrode capacity.

As illustrated in FIG. 2, by making the negative electrode insert lithium ion equivalent to (Q−A) (mAh) in advance, the negative electrode potential can be made equal to 0.2 V (vs. Li/Li⁺) upon charging to the rated cell voltage. However, in case when the carbon material is made to insert/extract lithium ion, there may exist an irreversible capacity caused by lithium ion that is inserted once in the carbon material but never extracted. For this reason, a difference in potential may occur between the first time charging/discharging and second or subsequent time charging/discharging. In such a case, the setting is preferably made on the basis of potential behavior upon the second or subsequent time charging/discharging.

In the embodiment illustrated in FIG. 1, the lithium reference electrode is inserted; however, even if the lithium reference electrode is not inserted, the negative electrode potential can be measured. For example, the negative electrode potential can be measured by taking out the positive electrode, negative electrode and separators from the container; immersing them in an electrolyte having the same composition as that of the in-use electrolyte; and setting the lithium reference electrode between the positive and negative electrodes. Based on the negative electrode potential measured in this manner, the capacitor according to the present invention can be configured.

### EXAMPLE

[Fabrication of Positive Electrode]

Activated carbon having a specific surface area of approximately 2200 m²/g obtained by an alkali activation method was used as the cathode active material. Powder of the activated carbon, acetylene black, and polyvinylidene fluoride were mixed to have a ratio by weight of 80:10:10, respectively, and then stirred in a solvent, N-methylpyrrolidone, to obtain a slurry. The slurry was coated on aluminum foil having a thickness of 30 μm by a doctor blade method, and temporarily dried, and then the aluminum foil was cut to have an electrode size of 20 mm×30 mm. A thickness of the electrode was approximately 50 μm. Before assembly of a cell, the electrode was dried at 120° C. for 10 hours in vacuum. A positive electrode capacity of the obtained electrode was 0.41 mAh.

[Fabrication of Negative Electrode]

The anode active material, acetylene black, and polyvinylidene fluoride were mixed to have a ratio by weight of 80:10:10, respectively, and then stirred in the solvent, N-methylpyrrolidone, to obtain a slurry. The slurry was coated on copper foil having a thickness of 18 μm by the doctor blade method, and temporarily dried, and then the copper foil was cut to have an electrode size of 20 mm×30 mm. A thickness of the electrode was approximately 50 μm. Before the cell assembly, the electrode was dried at 120° C. for 5 hours in vacuum.

The fabricated negative electrode was used to assemble a test cell using lithium metal as a counter electrode, and a discharge capacity was measured under the condition that the test cell was once charged to 0 V (vs. Li/Li⁺)with a constant current of 0.5 mA, and then discharged to 1.5 V (vs. Li/Li⁺). The discharge capacity is defined below as the negative electrode capacity.

As the anode active material, materials described below were used to fabricate the negative electrodes in Examples 1 to 6 and Comparative examples 1 to 3.

### COMPARATIVE EXAMPLE 1

As the anode active material, artificial graphite having a grain size of 10 to 50 μm was used. The negative electrode capacity of the electrode using the artificial graphite was measured to be 7.65 mAh. This negative electrode having such a capacity was made to insert lithium equivalent to 3.83 mAh. At this time, the negative electrode potential was 0.09 V (vs. Li/Li⁺).

### EXAMPLES 1 to 3 and COMPARATIVE EXAMPLES 2 and 3

As the anode active material, graphitizable carbon that had been formed by baking coke having an average grain size of 20 μm at 1200° C. was used. The negative electrode capacity for the case of using the graphitizable carbon was 3.84 mAh. This negative electrode was made to insert lithium in the manner described below such that the negative electrode potential upon charging to a rated cell voltage was 0.10 V (Comparative example 2), 0.15 V (Example 1), 0.20 V (Example 2), 0.25 V (Example 3), or 0.30 V (Comparative example 3). Note that the unit “V” here refers to “V (vs. Li/Li⁺)”.

The insertion of lithium into the negative electrode was conducted as follows: the negative electrode and lithium metal foil were set up in a beaker cell containing an electrolyte with a separator sandwiching them, and approximately 10 hours was taken to make the negative electrode insert a predetermined amount of lithium ions.

### EXAMPLES 4 to 6

In Example 2 described above, the capacity at the time when lithium was extracted until the negative electrode potential was changed from 0.20 V (vs. Li/Li⁺) to 1.5 V (vs. Li/Li⁺) was 2.20 mAh. This is equivalent to the above-described negative electrode capacity Q. In Example 2, a ratio A/Q of the positive electrode capacity A to the negative electrode capacity Q was 0.19.

By increasing the thickness of the positive electrode, the capacity ratio A/Q was adjusted to 0.36 (Example 4), 0.50 (Example 5), or 0.55 (Example 6).

[Preparation of Electrolyte]

The electrolyte was prepared by dissolving lithium hexafluorophosphate (LiPF₆) in a mixed solvent of ethylene carbonate and diethyl carbonate having a volume ratio of 3:7 so as to achieve a LiPF₆ concentration of 1 mol/liter.

[Fabrication of Capacitor]

A polyolefin-based separator was inserted between the above-described positive and negative electrodes, which was then impregnated with the electrolyte and hermetically sealed with a laminate cell. The completed cell was left for approximately 1 day before measurements.

In measurements for electrochemical evaluation, the laminate cell was sandwiched between two structure-preserving plates and then fixed by a clip to perform the measurements.

[Evaluation of Charge/Discharge Characteristics]

The discharge capacity was defined as a discharge capacity at the 5th one of cycles each of which consisted of constant current charging to 3.9 V with a predetermined current and constant current discharging to 2.0 V with a current the same as that for the charging. The charging/discharging current was any of 1C, 10C, and 60C, where 1C was a reference current capable of discharging a cell capacity for 1 hour.

A charge/discharge cycle test was performed under the cycle condition of constant current charging to 3.9 V with 10C and constant current discharging to 2.0 V with 10 C. As a cycle characteristic, a ratio of a discharge capacity after the 2000th cycle to an initial discharge capacity was defined as a capacity maintenance ratio (%).

The measurements were all performed at 25° C. Table 1 lists the discharge capacities under the 1C, 10C, and 60C discharging conditions, and capacity maintenance ratios after the 2000th cycle under the 10C condition, in Examples 1 to 3 and Comparative example 1 to 3.

TABLE 1

| | | | | | | Capacity |
|---|---|---|---|---|---|---|
| | | | Capacity | Capacity | Capacity | maintenance |
| | | Negative electrode | under 1C | under 10C | under 60C | ratio after |
| | Anode | potential at cell | discharging | discharging | discharging | 2000th cycle |
| | active | voltage of 3.9 V | condition | condition | condition | under 10C |
| | material | (V (vs. Li/Li⁺)) | (mAh) | (mAh) | (mAh) | condition(%) |
| Comparative | Artificial | 0.09 | 0.75 | 0.65 | 0.25 | 98 |
| example 1 | graphite | | | | | |
| Comparative | Graphitizable | 0.10 | 0.73 | 0.50 | 0.24 | 92 |
| example 2 | carbon | | | | | |
| Example 1 | Graphitizable | 0.15 | 0.72 | 0.59 | 0.45 | 93 |
| | carbon | | | | | |
| Example 2 | Graphitizable | 0.20 | 0.72 | 0.59 | 0.49 | 95 |
| | carbon | | | | | |
| Example 3 | Graphitizable | 0.25 | 0.71 | 0.58 | 0.46 | 87 |
| | carbon | | | | | |
| Comparative | Graphitizable | 0.30 | 0.69 | 0.51 | 0.32 | 65 |
| example 3 | carbon | | | | | |

As listed in Table 1, in Comparative examples 1 and 2, the capacities under the 60C discharging condition are significantly decreased. This may be because large current could not be applied due to the negative electrode potential significantly lower than 0.2 V (vs. Li/Li⁺). Also, in Comparative example 3, the capacity maintenance ratio after the 2000th cycle under the 10C condition is decreased, and the capacity under the 60C discharging condition is also decreased. This may be because decomposition of the electrolyte was facilitated due to a large positive electrode potential arising from the large negative electrode potential.

On the other hand, in Examples 1 to 3, the capacities under the 60C discharging condition are higher than those in Comparative examples 1 to 3, and also regarding the capacity maintenance ratios after the 2000th cycle under the 10C condition, the higher values are obtained.

Table 2 lists the capacities under the 1C discharging condition and the capacity maintenance ratios after the 2000th cycle under the 10C condition in Examples 4 to 6. In addition, Table 2 also lists these values of Example 2.

TABLE 2

| | Negative | | | | Capacity |
|---|---|---|---|---|---|
| | electrode | | | Capacity | maintenance |
| | capacity | Positive | | under 1C | ratio after |
| | from 0.2 | electrode | | discharging | 2000th cycle |
| | to 1.5 V | capacity | | condition | under 10C |
| | Q (mAh) | A (mAh) | A/Q | (mAh) | condition (%) |
| Example 2 | 2.20 | 0.41 | 0.19 | 0.72 | 95 |
| Example 4 | 2.20 | 0.80 | 0.36 | 0.92 | 93 |
| Example 5 | 2.20 | 1.10 | 0.50 | 1.01 | 82 |
| Example 6 | 2.20 | 1.20 | 0.55 | 0.69 | 44 |

As listed in Table 2, in Examples 4 and 5, the discharge capacities under the 1C discharging condition were increased because the positive electrode capacities were increased. However, the discharge capacities are not significantly increased compared with the increased amounts of the positive electrode capacities. This may be because the increase in the positive electrode capacity causes a large change in the negative electrode potential, which in turn causes the decrease in the discharge capacity. Also, in Example 6, the capacity ratio A/Q exceeds 0.5, and the capacity maintenance ratio after the 2000th cycle under the 10C condition is decreased. Also, even if the positive electrode capacity is decreased to decrease the capacity ratio A/Q below 0.10, the discharge capacity is only decreased without any improvement of the capacity maintenance ratio. Accordingly, the capacity ratio A/Q is preferable within the range of approximately 0.10 to 0.50.

Note that in Example 6, the capacity maintenance ratio after the 2000th cycle under the 10C condition is lower than those in Comparative examples 1 to 3 listed in Table 1 However, comparing with a cell of which the capacity ratio A/Q is adjusted to 0.55, which is the same as that in Example 6, and the negative electrode cutoff potential is adjusted to that in any of Comparative examples 1 to 3, Example 6 leads to a good result.

What is claimed is:

1. A capacitor comprising:
a positive electrode composed of a polarizable electrode containing activated carbon;
a negative electrode containing as an anode active material a carbon material capable of inserting or extracting lithium ion; and
a nonaqueous electrolyte containing lithium ion, wherein a charge cutoff potential for said negative electrode is within a range of approximately 0.15 to 0.25 V (vs. Li/Li⁺).

2. The capacitor according to claim 1, wherein said carbon material is graphitizable carbon.

3. The capacitor according to claim 1, wherein said carbon material is low crystalline graphitizable carbon

4. The capacitor according to claim 1, wherein a ratio A/Q of a positive electrode capacity A to a negative electrode capacity Q upon discharging of a potential of said negative electrode from the charge cutoff potential to approximately 1.5 V (vs. Li/Li⁺) is approximately 0.1 to 0.5.

5. The capacitor according to claim 1, wherein said carbon material is preliminarily doped with lithium before assembly of the capacitor.

6. The capacitor according to claim 1, charged/discharged with approximately 10C or higher.

7. The capacitor according to claim 1, charged/discharged with approximately 60C or higher.

8. The capacitor according to claim 1, wherein said nonaqueous electrolyte contains LiPF₆ as a solute.

9. The capacitor according to claim 8, wherein a concentration of a lithium salt in said nonaqueous electrolyte is approximately 0.1 to 2.5 mol/liter.

10. The capacitor according to claim 1, wherein said nonaqueous electrolyte contains ethylene carbonate as a solvent.

11. A method for manufacturing a capacitor including a positive electrode composed of a polarizable electrode containing activated carbon, a negative electrode containing a carbon material and a nonaqueous electrolyte containing lithium ion, the method comprising the steps of:
immersing the negative electrode and lithium metal in an electrolyte, the negative electrode and the lithium metal being brought into contact with each other; and
applying heat to the negative electrode and the lithium metal having been immersed in the electrolyte before assembly of the capacitor.

12. The method for manufacturing a capacitor according to claim 11, wherein a charge cutoff potential for said negative electrode is set within a range of approximately 0.15 to 0.25 V (vs. Li/Li⁺).

13. The method for manufacturing a capacitor according to claim 11, wherein a ratio A/Q of a positive electrode capacity A to a negative electrode capacity Q upon discharging of a potential of said negative electrode from a charge cutoff potential to approximately 1.5 V (vs. Li/Li⁺) is set to approximately 0.1 to 0.5.

14. The method for manufacturing a capacitor according to claim 11, wherein, graphitizable carbon is used as said carbon material.

15. The method for manufacturing a capacitor according to claim 11, wherein, low crystalline graphitizable carbon is used as said carbon material.

16. The method for manufacturing a capacitor according to claim 11, wherein in said nonaqueous electrolyte, LiPF₆ is contained as a solute.

17. A method for manufacturing a capacitor including a positive electrode composed of a polarizable electrode containing activated carbon, a negative electrode containing a carbon material, and a nonaqueous electrolyte containing lithium ion, the method comprising the steps of:
making the negative electrode and lithium metal face to each other via a separator; and
providing a constant current charge between the negative electrode and the lithium metal in an electrolyte before assembly of the capacitor.

18. The method for manufacturing a capacitor according to claim 17, wherein said constant current charge is provided for approximately 9 to 11 hours.

19. The method for manufacturing a capacitor according to claim 17, wherein a charge cutoff potential for said negative electrode is set within a range of approximately 0.15 to 0.25 V (vs. Li/Li⁺).

20. The method for manufacturing a capacitor according to claim 17, wherein a ratio A/Q of a positive electrode capacity A to a negative electrode capacity Q upon discharging of a potential of said negative electrode from a charge cutoff potential to approximately 1.5 V (vs. Li/Li⁺) is set to approximately 0.1 to 0.5.

21. The method for manufacturing a capacitor according to claim 17, wherein, graphitizable carbon is used as said carbon material.
